(19) United States
(12) Patent Application Publication
(10) Pub. No.: US 2010/0002201 A1
(43) Pub. Date: Jan. 7, 2010

(54) Modulized micro projection device

(76) Inventors: H0 Lu, Taipei (TW); Chih-Shun Huang, Taipei (TW); Tung-Chun Chiang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,486

(22) Filed: Jul. 7, 2008

(51) Int. Cl. G03B 21/20

(52) U.S. Cl. 353/85

(57) ABSTRACT

A modulized micro projection device is disclosed. The modulized micro projection device includes a case, a lens, an image module and a connection structure. The lens is disposed on one side of the case. The image module is disposed inside the case for projecting an image onto a screen through the lens. The connection structure is disposed on the outer surface of the case and holding a lighting module for providing light to the image module. Therefore, the lighting module is replaceable such that the luminance of the light can be changed through replacing the lighting module. Another modulized micro projection device is also disclosed.

### BACKGROUND

1. Field of Invention

The present invention relates to a projection device. More particularly, the present invention relates to a modulized micro projection device.

2. Description of Related Art

To reduce the size of the projection device for mobility (so called a micro projection device) becomes a popular issue lately. However, the reduced size of the micro projection device limits the selection of the light source and the cooling element. In addition, due to the low power supply of the micro projection device, the micro projection device can only project with poor luminance (about 10 lumens). However, the general projection device can project with thousands of lumens. Compared with the general projection device, the projecting ability of the micro projection device is not sufficient for general application.

Therefore, there is a need for a micro projection device to satisfy the size limitation of the micro projection device and provide sufficient projecting ability at the same time.

### SUMMARY

According to one embodiment of the present invention, a modulized micro projection device includes a case, a lens, an image module and a connection structure. The lens is disposed on one side of the case. The image module is disposed inside the case for projecting an image onto a screen through the lens. The connection structure is disposed on the outer surface of the case and holding a lighting module for providing light to the image module. Therefore, the lighting module is replaceable such that the luminance of the light can be changed through replacing the lighting module.

According to another embodiment of the present invention, a modulized micro projection device includes a case, a lens, an image module, a connection chamber and a hole. The lens is disposed on one side of the case. The image module is disposed inside the case for projecting an image onto a screen through the lens. The connection chamber is disposed inside the case and housing a lighting module for providing light to the image module. The hole is disposed on the case and exposing the connection chamber. Therefore, the lighting module is replaceable through the hole such that the luminance of the light can be changed through replacing the lighting module.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a modulized micro projection device according to one embodiment of this invention;

FIG. 2 illustrates the image module of FIG. 1;

FIG. 3 illustrates the lighting module of FIG. 1;

FIG. 4 illustrates the lighting module according to another embodiment of this invention;

FIG. 5 illustrates a modulized micro projection device according to yet another embodiment of this invention;

FIG. 6A is a three dimensional view of a modulized micro projection device according to still another embodiment of this invention; and

FIG. 6B is a schematic diagram of the modulized micro projection device of FIG. 6A.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

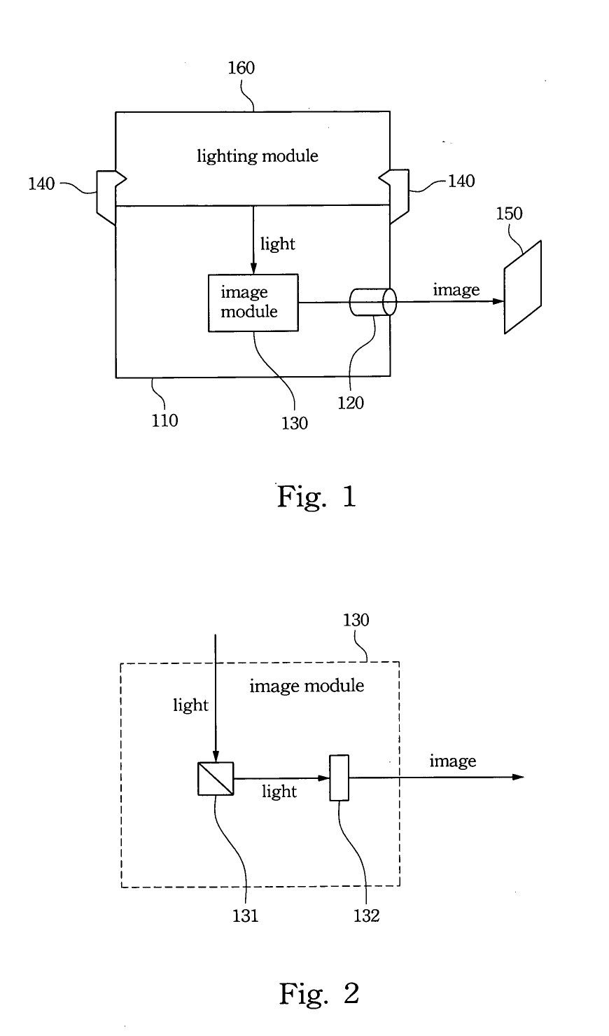

FIG. 1 illustrates a modulized micro projection device according to one embodiment of this invention. Referring to FIG. 1, the modulized micro projection device comprises a case 110, a lens 120, an image module 130 and a connection structure 140. The lens 120 is disposed on one side of the case 110. The image module 130 is disposed inside the case 110 for projecting an image onto a screen 150 through the lens 120. The connection structure 140 is disposed on the outer surface of the case 110 and holding a lighting module 160 for providing light to the image module 130, wherein the connection structure 140 is a hook set. Therefore, the lighting module 160 is replaceable such that the luminance of the light can be changed through replacing the lighting module 160.

FIG. 2 illustrates the image module 130 of FIG. 1. Referring to FIG. 2, the image module 130 may comprise a prism set 131. The prism set 131 is used for mixing and refracting the light provided by the lighting module 160.

Furthermore, the image module 130 may comprise a panel 132. The panel 132 is used for converting the light into the image.

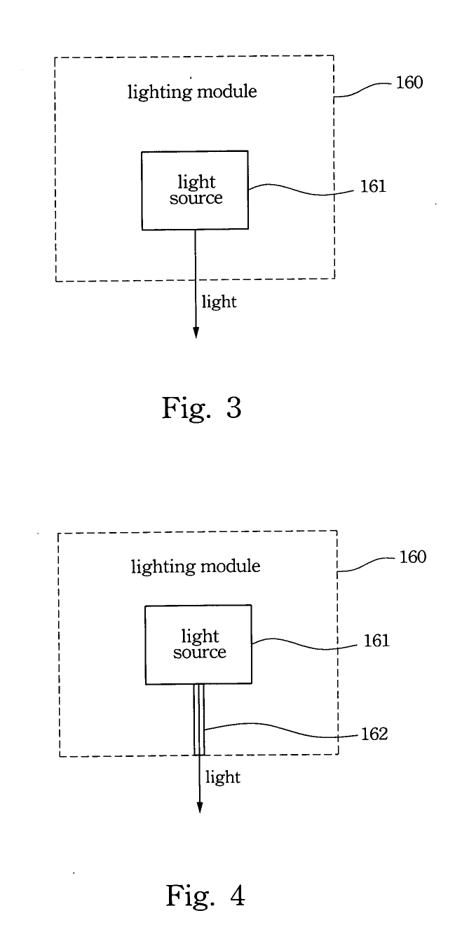

FIG. 3 illustrates the lighting module 160 of FIG. 1. The lighting module 160 comprises a light source 161. The light source 161 is used for emitting light, wherein the light source may be at least a light emitting diode (LED).

FIG. 4 illustrates the lighting module 160 according to another embodiment of this invention. The lighting module 160 comprises a light source 161 and a light-transferring medium 162. The light source 161 is used for emitting light through the light-transferring medium 162. The light source 161 may be at least a laser diode (LD), and the light-transferring medium 162 may be at least an optical fiber corresponding to the light source 161.

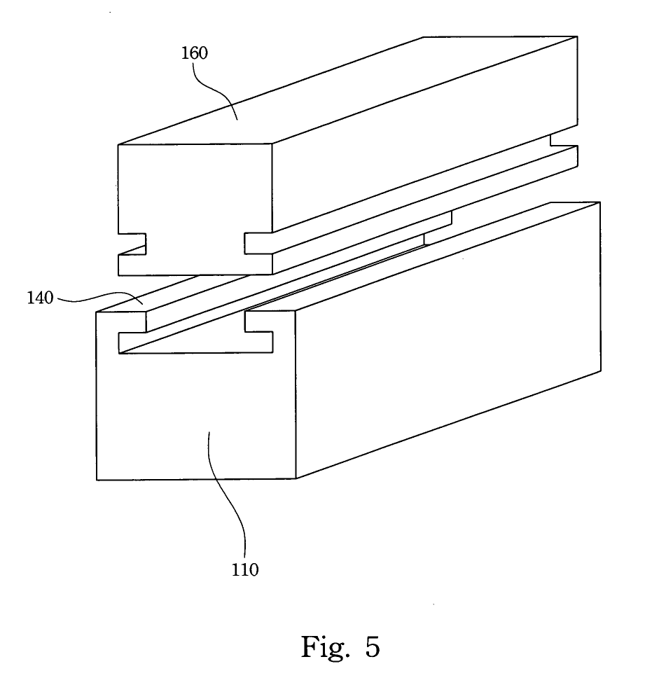

FIG. 5 illustrates a modulized micro projection device according to yet another embodiment of this invention. Referring to FIG. 5, the connection structure 140 is a track structure. Therefore, the lighting module 160 can be held through sliding the lighting module 160 into the connection structure 140, i.e. the track structure.

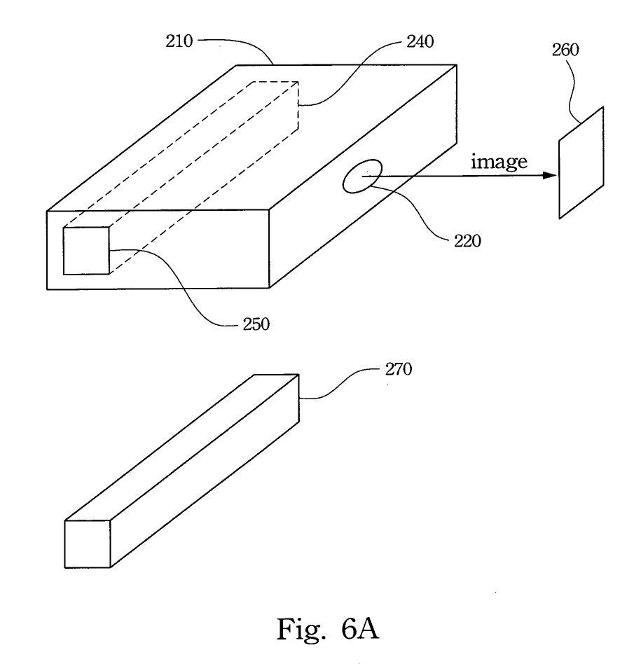

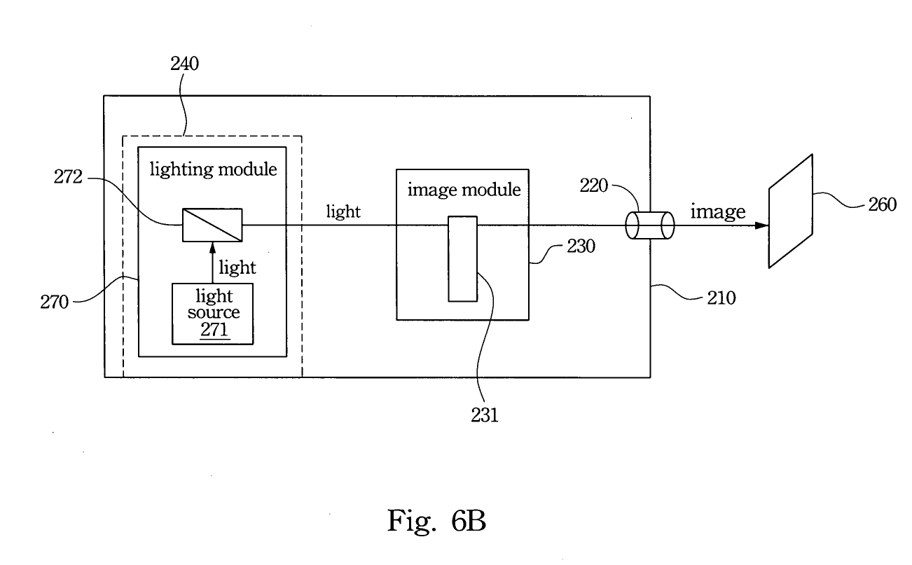

FIG. 6A is a three dimensional view of a modulized micro projection device according to still another embodiment of this invention. FIG. 6B is a schematic diagram of the modulized micro projection device of FIG. 6A. Referring to FIG. 6A and FIG. 6B, the modulized micro projection device comprises a case 210, a lens 220, an image module 230, a connection chamber 240 and a hole 250. The lens 220 is disposed on one side of the case 210. The image module 230 is disposed inside the case 210 for projecting an image onto a screen 260 through the lens 220. The connection chamber 240 is disposed inside the case 210 and housing a lighting module 270 for providing light to the image module 230. The hole 250 is disposed on the case 210 and exposing the connection chamber 240. Therefore, the lighting module 270 is replaceable through the hole 250 such that the luminance of the light can be changed through replacing the lighting module 270.

Furthermore, the image module 230 may comprise a panel 231. The panel 231 is used for converting the light into the image.

In addition, the lighting module 270 may comprise a light source 271 and a prism set 272. The light source 271 is used for emitting light, wherein the light source 271 may be at least a LED. The prism set 272 is used for mixing and refracting the light provided by the light source 271.

Although the present invention has been described in considerable detail with reference to certain embodiments thereof, other embodiments are possible. Therefore, their spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

Above all, the micro projection device is divided into an image module and a lighting module in this invention. Therefore, the micro projection device can replace several different lighting modules.

What is claimed is:

1. A modulized micro projection device comprising:
a case;
a lens disposed on one side of the case;
an image module disposed inside the case for projecting an image onto a screen through the lens; and
a connection structure disposed on the outer surface of the case and holding a lighting module for providing light to the image module,
wherein the lighting module is replaceable such that the luminance of the light can be changed through replacing the lighting module.

2. The modulized micro projection device of claim 1, wherein the image module comprises:
a prism set for mixing and refracting the light provided by the lighting module.

3. The modulized micro projection device of claim 1, wherein the image module comprises:
a panel for converting the light into the image.

4. The modulized micro projection device of claim 1, wherein the connection structure is a hook set.

5. The modulized micro projection device of claim 1, wherein the connection structure is a track structure.

6. A modulized micro projection device comprising:
a case;
a lens disposed on one side of the case;
an image module disposed inside the case for projecting an image onto a screen through the lens;
a connection chamber disposed inside the case and housing a lighting module for providing light to the image module;
a hole disposed on the case and exposing the connection chamber,
wherein the lighting module is replaceable through the hole such that the luminance of the light can be changed through replacing the lighting module.

7. The modulized micro projection device of claim 6, wherein the image module comprises:
a panel for converting the light into the image.
